(19) United States
(12) Patent Application Publication
(10) Pub. No.: US 2009/0005099 A1
(43) Pub. Date: Jan. 1, 2009

(54) Apparatus and method for supporting handover between home cell and macro cell in wireless communication system

(75) Inventors: Jin-Kwan Jung, Suwon-si (KR); Hyon-Goo Kang, Suwon-si (KR); In-Seok Hwang, Seoul-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/215,448

(22) Filed: Jun. 26, 2008

(30) Foreign Application Priority Data
Jun. 29, 2007 (KR) 2007-0064917

(51) Int. Cl. H04B 7/00

(52) U.S. Cl. 455/517

(57) ABSTRACT

An apparatus and a method for supporting a handover between a home cell and a macro cell in a wireless communication system are provided. A communicating method includes storing, at a mobile station (MS), information regarding a home cell to a memory; determining, at the mobile station, whether a stored neighbor base station (BS) list of the home cell includes a first base station; and when the neighbor base station list includes the first base station, scanning, at the mobile station, a home base station using the pre-registered home cell information.

### CROSS-REFERENCE TO RELATED APPLICATION(S) AND CLAIM OF PRIORITY

The present application claims the benefit under 35 U.S.C. §119(a) of a Korean patent application filed in the Korean Intellectual Property Office on Jun. 29, 2007 and assigned Serial No. 2007-64917, the entire disclosure of which is hereby incorporated by reference.

### TECHNICAL FIELD OF THE INVENTION

The present invention relates generally to an apparatus and a method for supporting a compact base station in a wireless communication system. More particularly, the present invention relates to an apparatus and a method for supporting a handover between a compact base station and a macro base station.

### BACKGROUND OF THE INVENTION

In a cellular broadband wireless communication system, each base stations communicates with terminals in its cell coverage using radio channels. The state of the radio channel changes according to movement of the terminal. If the terminal travels in a physically closed space, for example, in a shadow area such as an office or house, smooth communication is not feasible due to bad channel conditions between a base station and the terminal. To avoid this problem, installation of a compact base station, which serves as the base station in a small-scale shadow area such as an office or house, has been suggested.

The compact base station can be utilized in two situations. A compact base station can be utilized when an outer wall or an obstacle of a building blocks a user from being serviced by a macro base station installed by a provider, and when a user installs a compact base station in the house or the office to lower the service fee.

As such, when the compact base station (the home base station) is installed, a method for supporting a handover between the macro base station and the compact base station is required.

A handover procedure in a system where only macro cells are present is shown in FIG. 1 and described below.

A base station of a serving cell broadcasts a Mobile Neighbor Advertisement (MOB_NBR-ADV) message at time intervals. The MOB_NBR-ADV message is broadcast using a Broadcast Connection Identifier (BCID) so that every Mobile Station (MS) connected to the base station of the serving cell can receive the message. Namely, the MS can acquire information regarding neighbor base stations from the MOB_NBR-ADV message.

Meanwhile, the MS performs the scanning using the information regarding the neighbor base stations obtained from the NOB_NBR-ADV message. If necessary, the MS is allocated a scanning interval from the base station of the serving cell and measures a signal strength of the neighbor base stations through the scanning.

Upon determining the handover based on a result of the scanning, the MS transmits a Mobile Station Handover Request (MOB_MSHO-REQ) message to the base station of the serving cell. The base station of the serving cell identifies handover candidate base stations based on the MOB_MSHO-REQ message and collects capability information from the candidate base stations. Next, the base station of the serving cell transmits a MOB_BSHO-RSP message including the collected capability information of the candidate base stations to the MS. The MS determines a handover target base station using the MOB_BSHO-RSP message, sends a handover Indication (MOB_HO-IND) message including information regarding the target base station to the base station of the serving cell, and then hands over to the target base station.

In the system where only macro cells are present as shown in FIG. 1, the number of neighbor cells around the serving cell is quite small. Accordingly, even when the information regarding the neighbor cells is delivered in the MOB_NBR-ADV message, its load is not great, and fragmentation does not cause particular problems. Since the macro cell is operated as a public cell, there is no problem in transmitting the MOB_NBR-ADV message to every MS using the BCID.

However, in a system where home cells and macro cells coexist as shown in FIG. 2, it is difficult to broadcast information regarding neighbor cells using a MOB_NBR-ADV message because of a great number of the neighbor cells around the serving cell. Particularly, there can be tens or hundreds of home cells in one macro cell to service a home or a Small Office Home Office (SOHO). Moreover, most of the home cells are operated privately, i.e., access is granted only to specific users registered to the home cell.

In FIG. 2, an MS can handover between the macro cells or between the macro cell and the home cell. However, problems can occur in the handover as follows.

First, as the number of home cells adjacent to the serving cell increases, the increase of the size of the MOB_NBR-ADV message can waste radio resources. The MOB_NBR-ADV message, which contains information regarding the neighbor base stations, increases in proportion to the number of the neighbor base stations. The MOB_NBR-ADV message is encoded using a robust coding scheme. Hence, the increase of the size of the MOB_NBR-ADV message can more adversely affect the waste of the radio resources than the increase of the general traffic.

Second, as the size of the MOB_NBR-ADV message increases, the number of fragments also increases. Typically, the MS can normally operate upon receiving all the fragments of the MOB_NBR-ADV message. In other words, when not receiving all the fragments of the MOB_NBR-ADV message, the MS cannot perform the handover.

Third, a current MOB_NBR-ADV message can be fragmented up to 16 fragments and each fragment can carry information regarding 16 neighbor base stations at maximum. Accordingly, the MOB_NBR-ADV message can contain information regarding 256 neighbor base stations at maximum. Yet, the MOBNBR-ADV message in FIG. 2 should contain information regarding hundreds of the neighbor base stations. In conclusion, a present-day specification is not able to support the situation of FIG. 2.

Fourth, when the information regarding the home cells is broadcast using the MOB_NBR-ADV message, MSs not registered to the home cell may unnecessarily perform the scanning. When a signal of the home cell satisfies a handover start condition according to a result of scanning, the MS may attempt an unnecessary handover to the home cell. In this case, the radio resources and the network resources can be wasted. In addition, the MS needs to search for a handover target cell, which can result in a handover delay.

When the macro cell and the home cell coexist in the wireless communication system, what is needed is a method for addressing those problems.

### SUMMARY OF THE INVENTION

To address the above-discussed deficiencies of the prior art, it is a primary aspect of the present invention to address at least the above mentioned problems and/or disadvantages and to provide at least the advantages described below. Accordingly, an aspect of the present invention is to provide an apparatus and a method for supporting a handover between a home cell and a macro cell in a wireless communication system where the home cell and the macro cell coexist.

Another aspect of the present invention is to provide an apparatus and a method for scanning a home cell using pre-registered information regarding the home cell in a wireless communication system where the home cell and the macro cell coexist.

Yet another aspect of the present invention is to provide an apparatus and a method for updating home cell information registered to an MS in a wireless communication system where the home cell and the macro cell coexist.

Still another aspect of the present invention is to provide an apparatus and a method for a base station to broadcast only information regarding neighbor macro cells in a wireless communication system where a home cell and a macro cell coexist.

Further aspect of the present invention is to provide an apparatus and a method for scanning a home cell according to conditions in a wireless communication system where the home cell and the macro cell coexist.

The above aspects are achieved by providing a mobile station (MS) in a wireless communication system where a home cell and a macro cell coexist. The MS includes a storage for storing information regarding a home cell to which the MS is registered; a controller for, when accessing a first base station (BS), determining whether the first BS is a home BS using the information regarding the home cell; and a scanner for, when the first BS is the neighbor BS of the home BS, scanning neighbor BSs in a Mobile Neighbor Advertisement (MOB_NBR-ADV) message received from the first BS and the home BS under control of the controller.

According to one aspect of the present invention, an operating method of an MS in a wireless communication system where a home cell and a macro cell coexist, includes storing information regarding a home cell to which the MS is registered to a memory; when accessing a first BS, determining whether the first BS is a home BS using the information regarding the home cell; when the first BS is the neighbor BS of the home BS, scanning neighbor BSs in a Mobile Neighbor Advertisement (MOB_NBR-ADV) message received from the first BS and the home BS; and when the first BS is not the neighbor BS of the home BS, scanning neighbor BSs in the MOB_NBR-ADV message received from the first BS.

According to another aspect of the present invention, a communicating method in a wireless communication system where a home cell and a macro cell coexist, includes storing, at an MS, information regarding a home cell to a memory; determining, at the MS, whether a stored neighbor BS list of the home cell includes a first BS; and when the neighbor BS list includes the first BS, scanning, at the MS, a home BS using the stored home cell information.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication system including only macro cells;

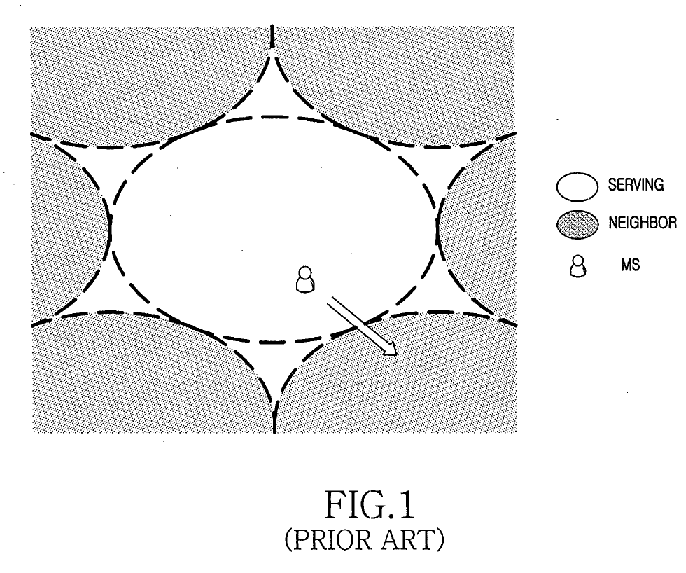

FIG. 2 illustrates a wireless communication system including home cells and macro cells;

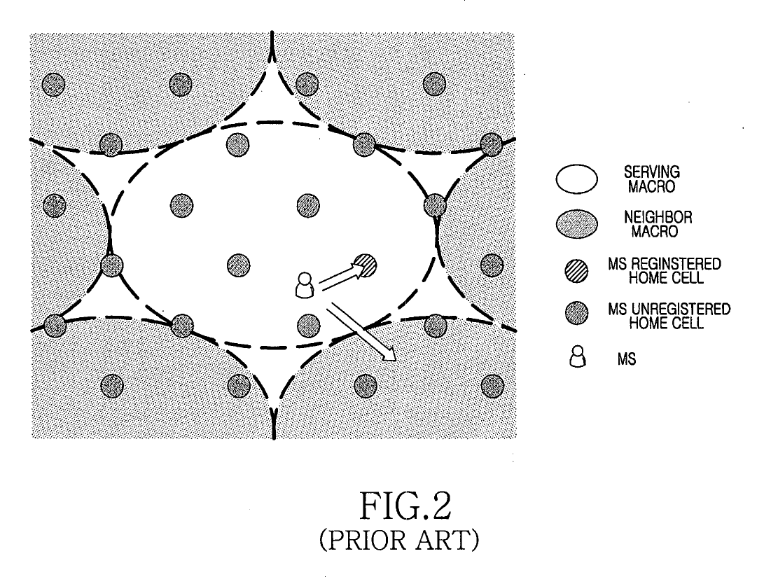

FIG. 3 illustrates a handover method between a home cell and a macro cell in a broadband wireless communication system according to an exemplary embodiment of the present invention;

FIG. 4 illustrates a method for updating home cell information at an MS according to an exemplary embodiment of the present invention;

FIG. 5 illustrates a method for scanning a home cell at the MS according to an exemplary embodiment of the present invention; and

FIG. 6 illustrates a structure of the MS in the broadband wireless communication system according to an exemplary embodiment of the present invention.

### DETAILED DESCRIPTION OF THE INVENTION

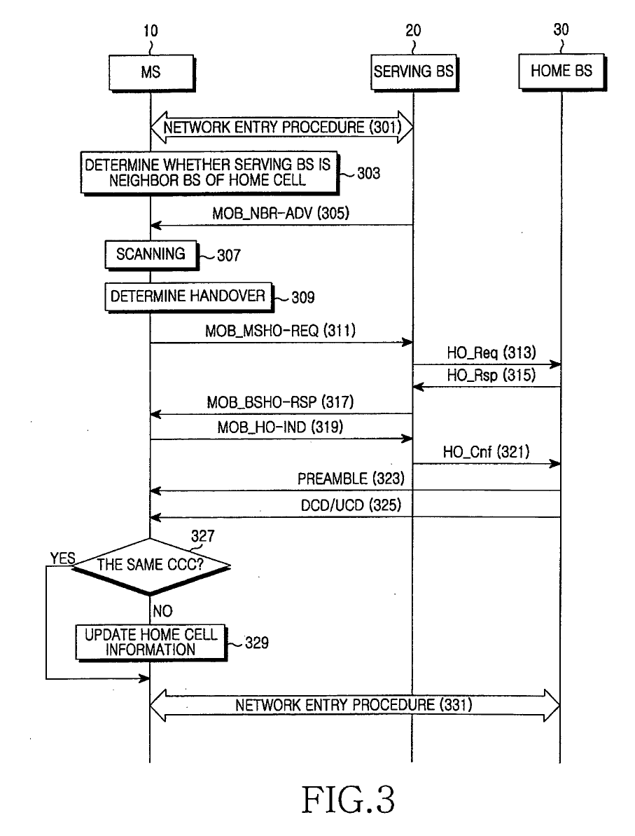

FIGS. 3 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication systems.

The present invention provides a technique for supporting a handover between a home cell and a macro cell in a wireless communication system where the home cell and the macro cell coexist. The present invention also provides a method for a base station to broadcast only information regarding neighbor macro cells. To handover from a macro cell to a home cell, a mobile station (MS) needs to know information regarding the home cell. It is assumed that the information regarding the home cell is registered to the MS in advance. More specifically, the information regarding the home cell can be registered to the MS by a user (or an operator) in person, or by a communication provider over the air (OTA). The MS can scan the home cell using the pre-registered information regarding the home cell without a separate Mobile Neighbor Advertisement (MOB_NBR-ADV) message and handover to the home cell. Herein, the information regarding the home cell, which is system parameter information periodically broadcast by a home base station, can include an identifier of the home base station, Uplink Channel Descriptor (UCD) information, Downlink Channel Descriptor (DCD) information, neighbor base station list information, and Configuration Change Count (CCC) information for checking validity of the UCD information and the DCD information.

Hereinafter, the wireless communication system employs, for example, Orthogonal Frequency Division Multiplexing (OFDM) scheme or Orthogonal Frequency Division Multiple Access (OFDMA) scheme. While a broadband wireless access communication system using a multi-carrier is explained by way of example, the present invention is applicable to any other wireless communication systems where a compact base station is installed.

Herein, the compact base station is a low-power base station installed by a user and can be called a micro base station, a self-configurable base station, an indoor base station, a home base station, and a femto base station.

FIG. 3 illustrates a handover method between a home cell and a macro cell in a broadband wireless communication system according to an exemplary embodiment of the present invention. An MS 10 is to handover from a serving Base Station (BS) 20 of a macro cell to a home BS 30 of a home cell. It is assumed that the MS 10 is a terminal registered to the home BS 30 and that the MS 10 always holds information regarding the home cell.

Upon accessing the serving BS 20, the MS 10 performs a network entry procedure with the serving BS 20 at step 301. The network entry procedure can include a ranging procedure, a basic capability negotiation procedure, an authentication procedure, and a registration procedure.

After the completion of the network entry procedure or in the process of the network entry procedure, the MS 10 determine whether a BS IDentifier (BSID) of the serving BS 20 is included in a neighbor BS list of the home cell at step 303. The BSID of the serving BS 20 can be acquired from a DCD message received from the serving BS 20. To determine whether the serving BS 20 is a neighbor BS of the home BS 30, the MS 10 compares the BSID of the serving BS 20 with the pre-registered neighbor BS list of the home cell.

At step 305, the serving BS 20 broadcasts a Mobile Neighbor Advertisement (MOB_NBR-ADV) message to the MS 10. Herein, the MOB_NBR-ADV message can be fragmented for the transmission, and the MS 10 can normally translate information regarding the neighbor BSs only upon receiving all the fragments.

After receiving the MOB_NBR-ADV message, the MS 10 acquires information regarding the neighbor BSs and scans the neighbor BSs using the acquired information at step 307. That is, the MS 10 measures a signal strength (e.g., Received Signal Strength Indication (RSSI) or Carrier to Interference and Noise Ratio (CINR)) of a reference signal (e.g., a preamble signal or a pilot signal) received from the neighbor BSs. When the serving BS 20 is a neighbor BS of the home cell, the MS 10 scans the home BS 30 and the neighbor BSs. When the serving BS 20 is not a neighbor BS of the home cell, the MS 10 scans merely neighbor BSs identified from the MOB_NBR-ADV message. Herein, since the MS 10 always holds information regarding its registered home cell, the MS 10 can scan the BS of the home cell using the stored information regarding the home cell. The information can include an identifier of the home BS, UCD information, DCD information, neighbor BS list information, and CCC information for checking validity of the UCD information and the DCD information.

After the scanning, the MS 10 determines whether to handover by comparing the scanning result (the received signal strength of the neighbor BSs) with the received signal strength of the serving BS 20 at step 309. When the received signal strength of the neighbor BS is greater than that of the serving BS 20, the MS 10 can determine to handover.

After a determination to handover is made, the MS 10 transmits a Mobile Station Handover Request (MOB_MSHO-REQ) message including a handover candidate BS list to the serving BS 20 at step 311. It is assumed that the candidate BS list includes the home BS 30. The serving BS 20 transmits a HandOver Request (HO_Req) message to the candidate BSs in the candidate BS list. In doing so, the serving BS 20 sends the HO_Req message to the home BS 30 at step 313. The HO_Req message can include bandwidth information and Quality of Service (QoS) information requested by the MS 10.

At step 315, the home BS 30 transmits a HO_Response (HO_Rsp) message to the serving BS 20 in reply to the HO_Req message. The HO_Rsp message can include bandwidth information and QoS information provided by the home BS 30.

At step 317, the serving BS 20 transmits a MOB_BSHO-RSP message including the information (the bandwidth information and the QoS information) of the candidate BS, which is obtained from the HO_Rsp message, to the MS 10. The MS 10 determines a handover target BS using the information in the MOB_BSHO-RSP message and transmits a MOB_HO-IND message including information regarding the target BS to the serving BS 20 at step 319. It is assumed that the target BS is determined to the home BS 30.

At step 321, the serving BS 20 identifies the target BS based on the MOB_HO-IND message, transmits a HO_Confirm (HO_Cnf) message to the target BS (the home BS), and then releases the connection to the MS 10.

At step 323, the MS 10 receives a preamble signal from the home BS 30 and acquires synchronization of the home BS 30 using the preamble signal. At step 325, the MS 10 receives a MAP message from the home BS 30 and receives a DCD message and a UCD message using resource allocation information of the MAP message (MAP IEs). Herein, the DCD message and the UCD message include system parameter information required for communications.

At step 327, the MS 10 checks whether the CCC value of the home BS 30 acquired from the DCD message is equal to the pre-stored CCC value of the home cell. The MS 10 determines whether an update of the home cell information is needed by comparing the CCC value received from the home cell BS with the pre-stored CCC value. When the two CCC values are the same, the MS 10 performs the network entry procedure with the home BS 30 using the pre-stored information regarding the home cell at step 331.

When the two CCC values are different from each other, the MS 10 updates the pre-stored home cell information with the latest information received from the home BS 30 at step 329. Next, the MS 10 performs the network entry procedure with the home BS 30 using the updated information regarding the home cell at step 331.

As such, the MS 10 recognizes a change of the home cell information by comparing the CCC value received from the home BS 30 with its own CCC value. When the home cell information is changed, the MS 10 updates the pre-stored home cell information with the latest information.

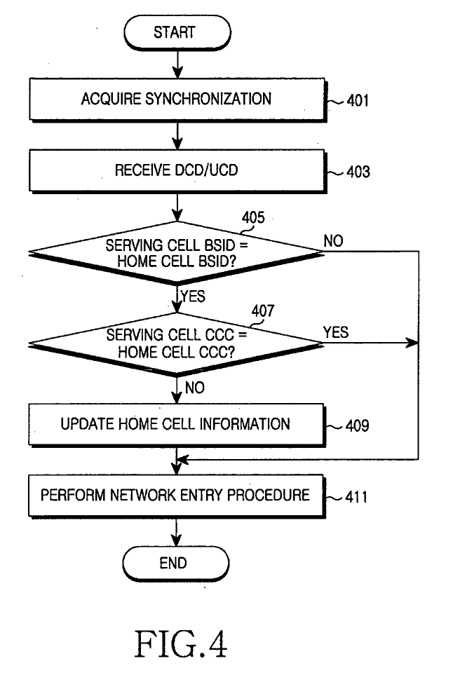

FIG. 4 illustrates a method for updating the home cell information at the MS according to an exemplary embodiment of the present invention.

When entering the network (or when re-entering the network), the MS receives a preamble signal (or a pilot signal) from a corresponding accessed BS and acquires synchronization using the preamble signal at step 401. At step 403, the MS receives a DL/UL-MAP from the BS and receives a DCD message and a UCD message using resource allocation information (MAP IEs) of the DL/UL-MAP.

At step 405, the MS checks whether a BSID acquired from the DCD message is the same as an ID of the home BS. Namely, the MS checks whether the BSID received from the current BS is the same as its BSID of the home cell. When the two BSIDs are different from each other, the MS performs the general network entry procedure at step 411.

By contrast, when the two BSIDs are the same, the MS checks whether a CCC value obtained from the DCD/UCD message is the same as its pre-stored CCC value at step 407. The MS determines whether an update of the home cell information is needed by comparing the CCC value received from the current home BS with its pre-stored CCC value.

When the two CCC values are the same, the MS performs the network entry procedure using the pre-stored home cell information at step 411. When the two CCC values are different from each other, the MS updates the pre-stored home cell information with the latest information received from the corresponding home BS at step 409. Next, the MS performs the network entry procedure using the updated home cell information with the home BS at step 411.

As such, the BS (the macro BS and the home BS) only broadcasts information regarding the macro BSs among the neighbor BSs using the MOB_NBR-ADV message. When a certain condition is satisfied, the MS registered to the home cell scans the home cell using its stored information.

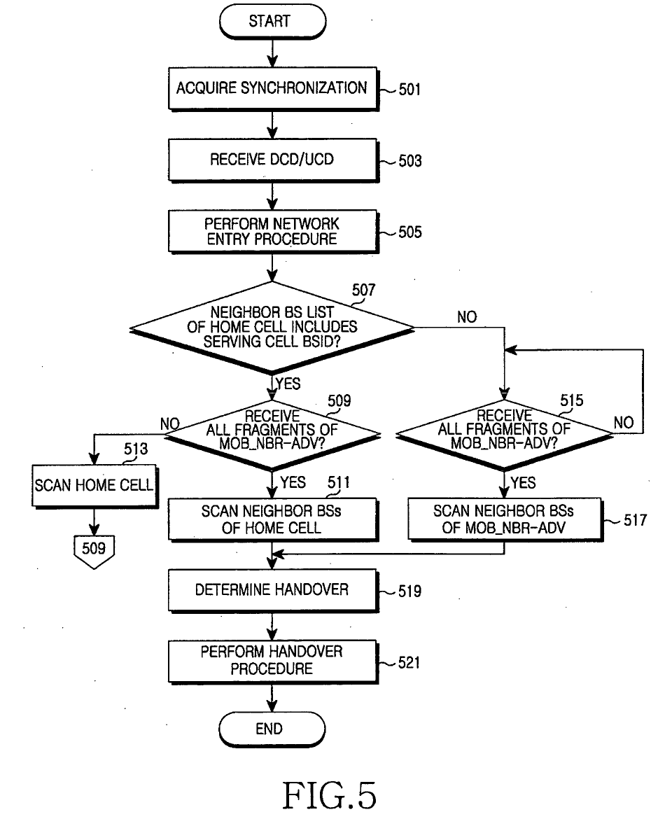

FIG. 5 illustrates a method for scanning the home cell at the MS according to an exemplary embodiment of the present invention.

When entering (or re-entering) the network, the MS receives a preamble signal from a corresponding accessed BS and acquires synchronization using the preamble signal at step 501. At step 503, the MS receives DL/UL-MAP from the BS and receives a DCD message and a UCD message using resource allocation information (MAP IEs) of the DL/UL-MAP. It is assumed that the BS is a macro BS.

At step 505, the MS acquires parameters required for communications, from the received DCD/UCD messages and performs the network entry procedure with the BS using the acquired parameters.

After or during the network entry procedure, the MS determines whether a BSID received from the BS is included in a neighbor BS list of the home cell at step 507, i.e., the MS determines whether the BS is a neighbor BS of the home cell.

When the BSID of the serving BS is included in the neighbor BS list of the home cell, the MS determines whether all of fragments of a MOB_NBR-ADV message are received from the BS at step 509. If the MS does not receive all the fragments, the MS scans the BS of the home cell using pre-stored home cell information at step 513 and goes back to step 509. In doing so, when determining the necessity of the handover as a result of the home cell scanning, the MS can perform a handover procedure. When the MS receives all the fragments of the MOB_NBR-ADV message, the MS scans the BS of the home cell and the neighbor BSs of the MOB_NBR-ADV message at step 511 and proceeds to step 519.

By contrast, when the BS is not a neighbor BS of the home cell, the MS determines whether all fragments of a MOB_NBR-ADV message are received from the BS at step 515. When the MS does not receive all the fragments, the MS stands by to receive all the fragments. Upon receiving all the fragments of the MOB_NBR-ADV message, the MS scans the neighbor BSs of the MOB_NBR-ADV message at step 517 and then goes to step 519.

At step 519, the MS determines whether to handover using the scanning result (the signal strength of the neighbor BSs) and the signal strength of the serving BS. When the signal strength of the neighbor BS is greater than that of the serving BS, the MS can determine to handover. Upon determining to handover, the MS performs the handover procedure with the serving BS at step 521 and then enters the target BS.

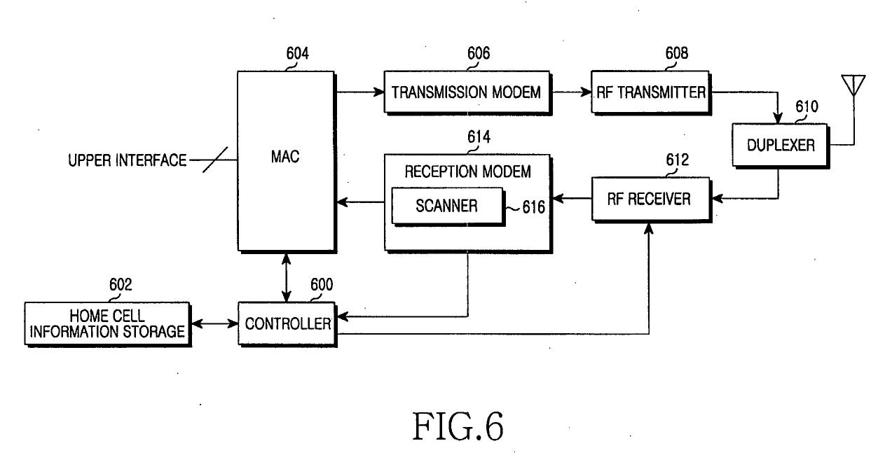

FIG. 6 is a block diagram of the MS in the broadband wireless communication system according to an exemplary embodiment of the present invention. Hereinafter, a Time Division Duplex (TDD)-OFDMA system is described. Note that the present invention is applicable to a Frequency Division Duplex (FDD)-OFDMA system and a hybrid system using both the TDD and the FDD.

The MS of FIG. 6 includes a controller 600, a home cell information storage 602, a Media Access Control (MAC) layer part 604 connected to an upper layer (not shown), a transmission modem 606, a Radio Frequency (RF) transmitter 608, a duplexer 610, an RF receiver 612, and a reception modem 614.

The controller 600 controls the operations of the MS in association with the MAC layer part 604. The home cell information storage 602 contains home cell information input from a user (or an operator). Herein, the home cell information can include a BSID of the home BS, UCD information, DCD information, neighbor BS list information, and CCC information for verifying the UCD information and the DCD information.

The controller 600 manages the home cell information stored to the home cell information storage 602, and controls the home cell scanning using the home cell information. More specifically, the controller 600 determines whether the serving BS is a neighbor BS of the home cell when entering (or re-entering) the network, and includes the home cell to the neighbor BS scanning when the serving BS is the neighbor BS of the home cell. That is, the controller 600 controls a scanner 616 to scan not only the neighbor BSs of the MOB_NBR-ADV message received from the serving BS but also the BS of the home cell. If an inter-Frequency Allocation (FA) scanning is necessary, the controller 600 can control the RF receiver 612 to scan a different FA. As such, without the BSs broadcasting the information regarding the neighbor home cell, the MS can scan its registered home cell if necessary. When the conditions are satisfied, the MS can handover to the home cell.

When entering the home cell, the controller 600 can determine whether an update of the home cell information is needed or not by comparing the CCC value of the DCD/UCD received from the home cell with the DCD/UCD CCC value stored to the home cell information storage 602. When the CCC value received from the home cell differs from the pre-stored CCC value, the controller 600 updates the home cell information pre-stored to the home cell information storage 602 with the latest information (the DCD information, the UCD information, the neighbor BS list, and so forth) received from the home cell. Thus, it is possible to flexibly cope with the change of the system parameters of the home BS.

The MAC layer part 604 receives transmit data from the upper layer (e.g., Internet Protocol (IP) layer part), processes the transmit data in conformity with an interfacing scheme of the transmission modem 606, and forwards the processed data to the transmission modem 606. The MAC layer part 604 receives receive data from the reception modem 614, processes the receive data in conformity with an interfacing scheme of the upper layer, and forwards the processed data to the upper layer.

The transmission modem 606 encodes (or baseband-processes) the packets (data bursts) from the MAC layer part 604 in the physical layer and then outputs the encoded packets. Herein, the transmission modem 606 can include a channel encoder, an interleaver, a modulator, and an Inverse Fast Fourier Transform (IFFT) operator. The RF transmitter 608 includes a frequency converter, a filter, and an amplifier. The RF transmitter 608 converts the baseband data output from the transmission modem 606 to an analog signal and converts the analog baseband signal to an RF signal.

The duplexer 610 forwards a receive signal from an antenna to the RF receiver 612 and forwards a transmit signal output from the RF transmitter 608 to the antenna according to the duplexing. The RF receiver 612 includes an amplifier, a frequency converter, and a filter. The RF receiver 612 converts the RF signal output from the duplexer 610 to a baseband signal and converts the analog baseband signal to digital data.

The reception modem 614 decodes the data output from the RF receiver 612 in the physical layer. Herein, the reception modem 614 can include a FFT operator, a demodulator, a deinterleaver, and a channel decoder. The reception modem 614 includes the scanner 616 for measuring the signal strength of the neighbor BSs. The scanner 616 measures the signal strength (e.g., RSSI or CINR) of the neighbor BS during the scanning duration under the control of the controller 600 and provides the scanning result to the controller 600.

As set forth above, in the wireless communication system where the home cell and the macro cell coexist, the MS can scan the home cell using the pre-registered home cell information and handover to the home cell, without the BS's broadcasting the neighbor home cell information.

Consequently, the BS can avoid the waste of radio resources caused by broadcasting information regarding all the neighbor home cells. In more detail, since the MS pre-stores the information regarding its registered home cell, the increase of the size of the MOB_NBR-ADV message due to the home cell can be prevented. As with handover from the macro cell to the home cell, the MS can handover even before receiving the MOB_NBR-ADV message. In addition, it is possible to block an MS unregistered to the home cell from unnecessarily scanning the home cell. Furthermore, when the unregistered MS unnecessarily attempts the handover to the home cell, waste of the radio resources and the network resources can be avoided. The success rate of the handover can be raised.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile station in a wireless communication system where a home cell and a macro cell coexist, comprising:
a storage for storing information regarding a home cell to which the mobile station is registered; and
a controller for, when accessing a first Base Station (BS) determining whether the first base station is a home base station using the information regarding the home cell.

2. The mobile station of claim 1, wherein the information regarding the home cell comprises at least one of an identifier of the home base station, system parameter information, neighbor base station list information, and information for checking validity of the home cell information.

3. The mobile station of claim 1, wherein the information regarding the home cell comprises at least one of a base station IDentifier (BSID) of the home base station, Uplink Channel Descriptor (UCD) information, Downlink Channel Descriptor (DCD) information, neighbor base station list information, and Configuration Change Count (CCC) information for checking validity of the UCD information and the DCD information.

4. The mobile station of claim 1, wherein the information regarding the home cell is registered to the mobile station by input of a user or by a provider over the air (OTA).

5. The mobile station of claim 1, wherein, when the first base station is the home base station, the controller compares a specific CCC value received from the first base station with a CCC value of the home cell, which is stored to the storage, and updates the home cell information of the storage with latest information received from the first base station when the two CCC values are different from each other.

6. The mobile station of claim 5, wherein the CCC value comprises at least one of a DCD CCC and a UCD CCC.

7. The mobile station of claim 1, wherein, when the first base station is not the home base station, the controller determines whether the first base station is a neighbor base station of the home base station using the information regarding the home cell.

8. The mobile station of claim 7, further comprising:
a scanner for, when the first base station is the neighbor base station of the home base station, scanning neighbor base stations in a Mobile Neighbor Advertisement (MOB_NBR-ADV) message received from the first base station, and the home base station under control of the controller.

9. The mobile station of claim 8, wherein, when the first base station is not the neighbor base station of the home base station, the scanner scans the neighbor base stations in the MOB_NBR-ADV message received from the first base station.

10. The mobile station of claim 8, wherein the MOB_NBR-ADV message comprises information regarding macro base stations.

11. The mobile station of claim 8, wherein the controller determines whether to handover using a signal strength of the neighbor base stations, a signal strength of the home Base Station, and a signal strength of the first base station, which are provided from the scanner.

12. The mobile station of claim 8, wherein, when the first base station is a neighbor base station of the home base station, the scanner scans the home base station under the control of the controller before receiving the MOB_NBR-ADV message.

13. An operating method of a Mobile Station (MS) in a wireless communication system where a home cell and a macro cell coexist, the method comprising:
storing information regarding a home cell to which the mobile station is registered to a memory; and
when accessing a first Base Station (BS), determining whether the first base station is a home base station using the information regarding the home cell.

14. The operating method of claim 13, wherein the information regarding the home cell comprises at least one of an identifier of the home base station, system parameter information, neighbor base station list information, and information for checking validity of the home cell information.

15. The operating method of claim 13, wherein the information regarding the home cell comprises at least one of a base station IDentifier (BSID) of the home base station, Uplink Channel Descriptor (UCD) information, Downlink Channel Descriptor (DCD) information, neighbor base station list information, and Configuration Change Count (CCC) information for checking validity of the UCD information and the DCD information.

16. The operating method of claim 13, wherein the information regarding the home cell is registered to the mobile station by input of a user or by a provider over the air (OTA).

17. The operating method of claim 13, further comprising:
when the first base station is the home base station, comparing a specific CCC value received from the first base station with a CCC value of the stored home cell information; and
when the two CCC values are different from each other, updating the stored home cell information with latest information received from the first base station.

18. The operating method of claim 17, wherein the CCC value comprises at least one of a DCD CCC and a UCD CCC.

19. The operating method of claim 13, further comprising:
when the first base station is not the home base station, determining whether the first base station is a neighbor base station of the home base station using the information regarding the home cell.

20. The operating method of claim 19, wherein the MOB_NBR-ADV message comprises information regarding macro base stations.

21. The operating method of claim 19, further comprising:
when the first base station is the neighbor base station of the home base station, scanning neighbor base stations in a Mobile Neighbor Advertisement (MOB_NBR-ADV) message received from the first base station and the home base station; and
when the first base station is not the neighbor base station of the home base station, scanning neighbor base stations in the MOB_NBR-ADV message received from the first base station.

22. The operating method of claim 21, further comprising:
determining whether to handover using a signal strength of the neighbor base stations, a signal strength of the home base station, and a signal strength of the first base station, which are acquired through the scanning.

23. The operating method of claim 19, further comprising:
when the first base station is a neighbor base station of the home base station, scanning the home base station under the control of the controller before receiving the MOB_NBR-ADV message.

24. The operating method of claim 13, further comprising:
when the first base station is the home base station, performing a network entry procedure with the first base station using the stored information regarding the home cell.

25. A communicating method in a wireless communication system where a home cell and a macro cell coexist, the method comprising:
storing, at a mobile station (MS), information regarding a home cell to a memory;
determining, at the mobile station, whether a stored neighbor base station (BS) list of the home cell includes a first base station; and
when the neighbor base station list includes the first base station, scanning, at the mobile station, a home base station using the stored home cell information.

26. The communicating method of claim 25, further comprising:
when accessing the home base station, comparing, at the mobile station, a specific count value received from the home base station with a count value of the stored home cell information; and
when the count vales are different from each other, updating, at the mobile station, the stored home cell information with latest information received from the home base station.

27. The communicating method of claim 25, further comprising:
broadcasting, at the first base station, a Mobile Neighbor Advertisement (MOB_NBR-ADV) message which comprises information regarding neighbor macro base stations;
scanning, at the mobile station, neighbor base stations of the MOB_NBR-ADV message; and
determining, at the mobile station, whether to handover using a scanning result of the neighbor base stations and a scanning result of the home base station.

28. The communicating method of claim 25, wherein the information regarding the home cell comprises at least one of an identifier of the home base station, system parameter information, neighbor base station list information, and information for checking validity of the home cell information.

29. The communicating method of claim 25, wherein the information regarding the home cell comprises at least one of a base station IDentifier (BSID) of the home base station, Uplink Channel Descriptor (UCD) information, Downlink Channel Descriptor (DCD) information, neighbor base station list information, and Configuration Change Count (CCC) information for checking validity of the UCD information and the DCD information.

30. The communicating method of claim 25, wherein the information regarding the home cell is registered to the mobile station by input of a user or by a provider over the air (OTA).
